(19) United States
(12) Patent Application Publication
(10) Pub. No.: US 2025/0196299 A1
(43) Pub. Date: Jun. 19, 2025

(54) ANTI-SLIP FASTENER DRIVER

(71) Applicant: Hong Ann Tool Industries Co., Ltd., Taichung City (TW)

(72) Inventor: Cheng-Wei SU, Taichung City (TW)

(21) Appl. No.: 18/916,106

(22) Filed: Oct. 15, 2024

Related U.S. Application Data
(63) Continuation-in-part of application No. 18/538,158, filed on Dec. 13, 2023.

(51) Int. Cl. B25B 15/00

(52) U.S. Cl. CPC B25B 15/005

(57) ABSTRACT

An anti-slip fastener driver includes a shank, a driving portion, and a plurality of engaging recesses. The driving portion is formed on an end of the shank and includes a top end face, a plurality of outer peripheral faces, a plurality of driving recesses formed on the top end face, and a base spaced from the top end face. each driving recess has a bevel face and a driving face. The engaging recesses are respectively formed on the outer peripheral faces. Each engaging recess (40b; 40c) extends into the driving portion from the bevel face of each driving recess towards the base.

### CROSS-REFERENCE

The present application is a continuation-in-part application of U.S. patent application Ser. No. 18/538,158, filed on Dec. 13, 2023, now pending, which claims priority of U.S. patent application Ser. No. 17/141,244, filed on Jan. 5, 2021, now abandoned, which claims priority of Taiwan patent application Ser. No. 109140586, filed on Nov. 19, 2020, of which the entire disclosure is incorporated herein by reference for all purposes.

### BACKGROUND OF THE INVENTION

The present invention relates to anti-slip fastener drivers.

A conventional fastener driver, such as a hexagonal wrench, a screwdriver, etc. is a hand tool that is usually used to driver a fastener, such as a bolt or a screw. Considering the costs and the fact that the fasteners are common expendables, the fasteners are generally made of materials softer than the fastener drivers, resulting in wear of the fasteners while being driven by the fastener drivers. Furthermore, a fastener forcibly driven by a fastener driver of a size not matching with the fastener will wear, too. The wear of a fastener result in damage to a driving hole of the fastener. In a case that the driving hole of the fastener becomes a nearly circular hole, when the fastener driver engages with the driving hole and rotates to drive the fastener, the fastener driver slips relative to the fastener, failing to effectively drive the fastener.

In view of the above drawbacks of the conventional structure, Applicant has designed an anti-slip fastener driver that mitigates and/or obviates the above disadvantages.

### SUMMARY OF THE INVENTION

An objective of the present invention is to provide an anti-slip fastener driver, which includes a shank, a driving portion, and a plurality of engaging recesses. The driving portion is formed on an end of the shank and includes a top end face, a plurality of outer peripheral faces radially positioned about a longitudinal axis of the driving portion, a plurality of driving recesses formed on the top end face and sequentially arranged about the longitudinal axis, and a base spaced from the top end face along the longitudinal axis. Each of the plurality of driving recesses has a bevel face inclinedly connected to the top end face at an inclination angle, and a driving face perpendicularly connected to the top end face. The plurality of engaging recesses are respectively formed on the plurality of outer peripheral faces. Each of plurality of engaging recesses extends into the driving portion from the bevel face of each of the plurality of driving recesses towards the base.

In an example, the number of the plurality of outer peripheral faces is six, and the driving portion has a regular hexagonal cross-sectional shape. The number of the plurality of driving recesses is six.

In an example, each of the plurality of outer peripheral faces is a trapezoid surface having a top short side adjacently connected to the top end face, a bottom long side adjacently connected to the base, a first lateral side, and a second lateral side parallel to the first lateral side.

In an example, the top short side is shorter than a half of the bottom long side.

In an example, the first lateral side is shorter than the second lateral side.

In an example, each of plurality of engaging recesses is spaced from the first lateral side of each of the plurality of outer peripheral faces by a first distance and spaced from the second lateral side of each of the plurality of outer peripheral faces by a second distance. The first distance is less than the second distance.

In an example, each of plurality of engaging recesses extends perpendicularly into each of the plurality of outer peripheral faces.

In another example, each of plurality of engaging recesses extends obliquely into each of the plurality of outer peripheral faces.

In an example, the inclination angle is in a range of 130 degrees to 175 degrees.

In an example, each of the plurality of driving recesses further has a first driving edge adjacently connected to the top end face and the respective bevel face, and a second driving edge adjacently connected to the top end face and the respective driving face.

In an example, an included angle is formed between the first driving edge and the second driving edge, and the included angle is between 50 degrees to 60 degrees.

In an example, the top end face is flat.

In another example, the top end face is inclined and slopes downward from the longitudinal axis to the top short side of each of the plurality of outer peripheral faces.

In another example, each of the plurality of engaging recesses extends into the driving portion from the bevel face of each of the plurality of driving recesses towards the base and crosses over to the base.

The present invention will become clearer in light of the following detailed description of illustrative embodiments of this invention described in connection with the drawings.

### BRIEF DESCRIPTION OF DRAWINGS

FIG. 1 is a perspective view of an anti-slip fastener driver of a first embodiment according to the present invention.

FIG. 2 is a partial, side elevational view of the anti-slip fastener driver of FIG. 1.

FIG. 3 is an end elevational view of the anti-slip fastener driver of FIG. 1.

FIGS. 4 and 5 are illustration views for illustrating the anti-slip fastener driver driving a damaged screw.

FIG. 6 is a perspective view of an anti-slip fastener driver of a second embodiment according to the present invention.

FIG. 7 is a partial, side elevational view of the anti-slip fastener driver of FIG. 6.

FIG. 8 is an end elevational view of the anti-slip fastener driver of FIG. 6.

FIG. 9 is a perspective view of an anti-slip fastener driver of a third embodiment according to the present invention.

FIG. 10 is a partial, side elevational view of the anti-slip fastener driver of FIG. 9.

FIG. 11 is an end elevational view of the anti-slip fastener driver of FIG. 9.

FIG. 12 is a perspective view of an anti-slip fastener driver of a fourth embodiment according to the present invention.

FIG. 13 is a partial, side elevational view of the anti-slip fastener driver of FIG. 12.

FIG. 14 is an end elevational view of the anti-slip fastener driver of FIG. 12.

FIG. 15 is a perspective view of an anti-slip fastener driver of a fifth embodiment according to the present invention.

FIG. 16 is a partial, side elevational view of the anti-slip fastener driver of FIG. 15.

### DETAILED DESCRIPTION OF THE INVENTION

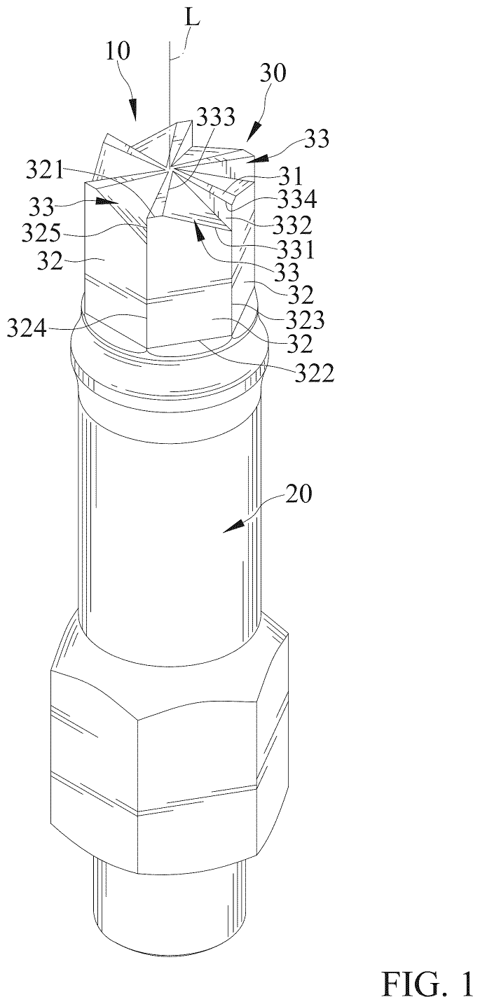

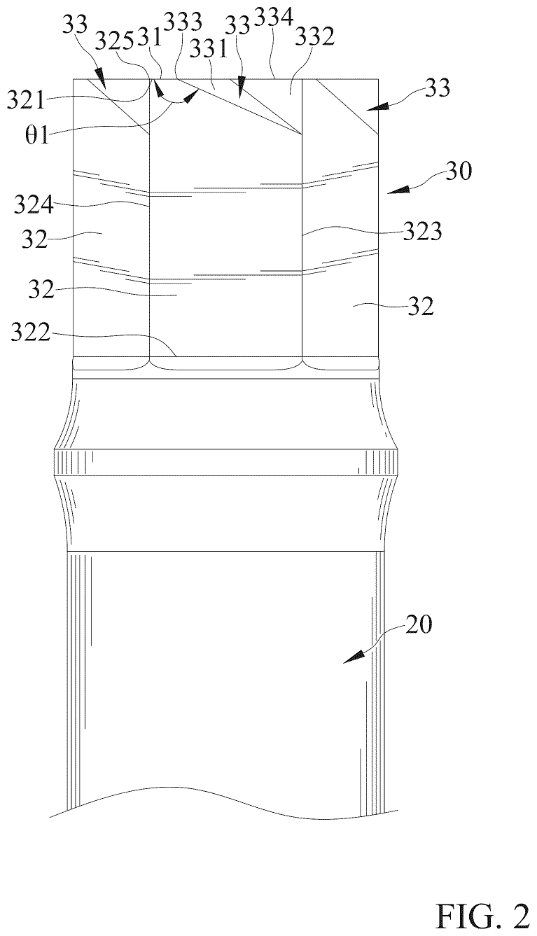

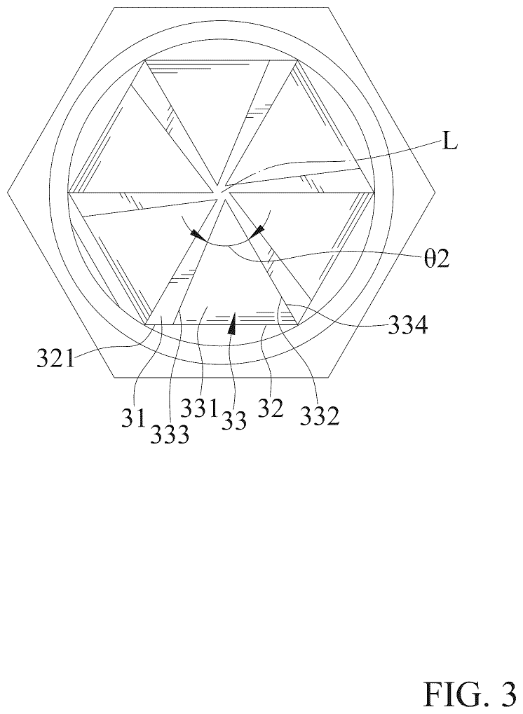

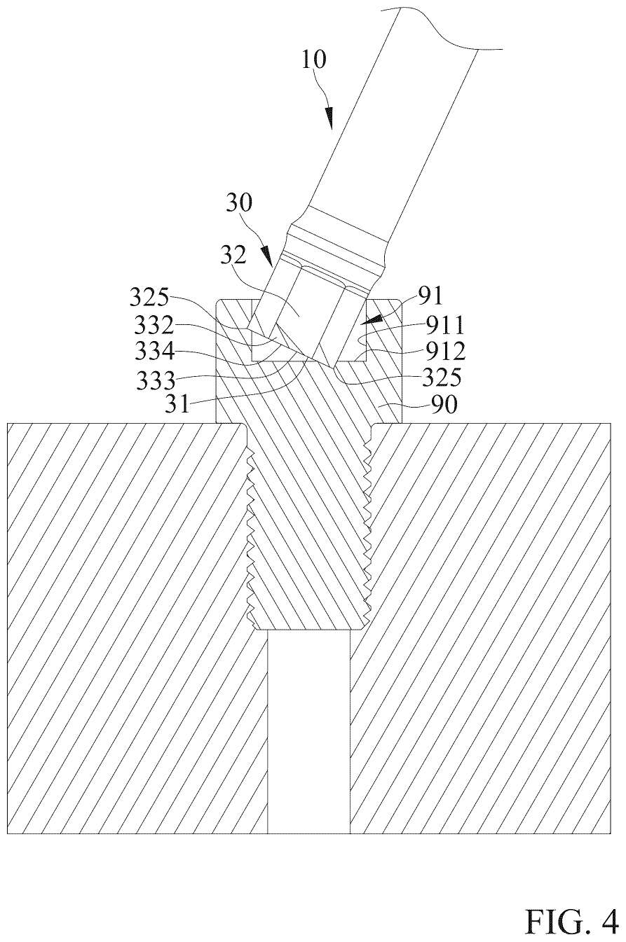

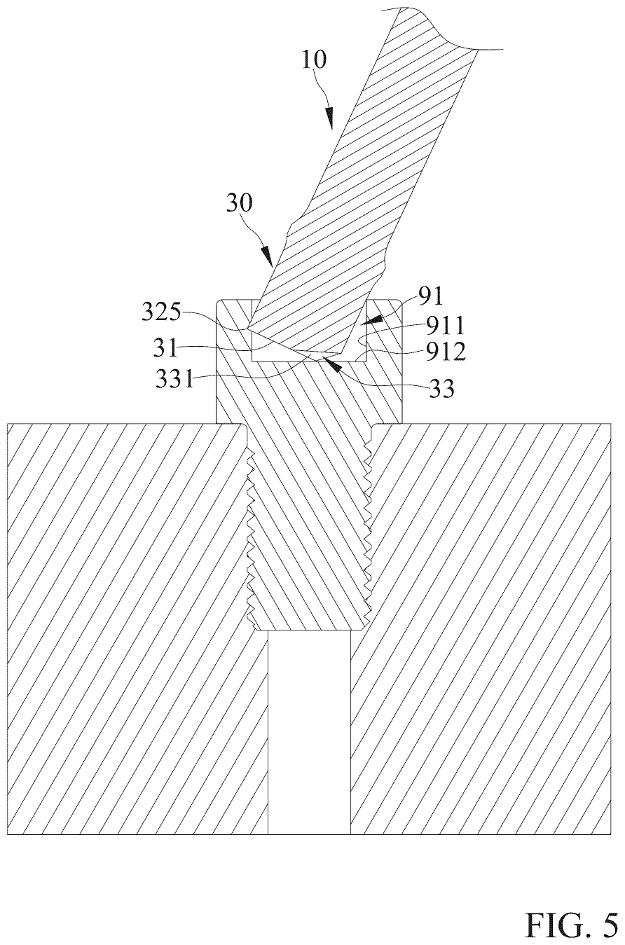

FIGS. 1-5 show an anti-slip fastener driver 10 of a first embodiment according to the present invention. The anti-slip fastener driver 10 includes a shank 20 and a driving portion 30 formed on an end of the shank 20. The driving portion 30 defines a longitudinal axis L extending therethrough, allowing the driving portion 30 being rotatable about the longitudinal axis L. The driving portion 30 has a top end face 31 extending perpendicularly to the longitudinal axis L, a plurality of outer peripheral faces 32 arranged continuous and surrounding the longitudinal axis L, and a plurality of driving recesses 33 formed on the top end face 31 and sequentially arranged around the longitudinal axis L. Each of the plurality of driving recesses 33 has a bevel face 331 inclinedly connected to the top end face 31 at an inclination angle θ1, and a driving face 332 perpendicularly connected to the top end face 31.

Further, the number of the plurality of outer peripheral faces 32 is six to cause the driving portion 30 having a regular hexagonal cross-sectional shape, and the number of the plurality of driving recesses 33 is six. Thus, the top end face 31 in the embodiment is formed as an outwardly extending fan-shaped surface from the longitudinal axis L.

Each of the plurality of outer peripheral faces 32 is a right trapezoid surface, which has a top short side 321 adjacently connected to the top end face 31, a bottom long side 322 parallel to the top short side 321 and connected to the shank 20, and a first lateral side 323 and a second lateral side 324 parallel to each other and respectively connected to adjacent outer peripheral faces 32. The first lateral side 323 is lees than the second lateral side 324.

The length of the top short side 321 may be less than a half of the length of bottom long side 322. In the embodiment, the length of the top short side 321 is less than one third of the length of bottom long side 322.

Furthermore, the inclination angle θ1 of the embodiment is in a range of 130 degrees to 175 degrees, preferably in the range of 150 degrees to 160 degrees.

Each of the plurality of driving recesses 33 further has a first driving edge 333 adjacently connected to the top end face 31 and the respective bevel face 331, and a second driving edge 334 adjacently connected to the top end face 31 and the respective driving face 332.

In the embodiment, an included angle θ2 is formed between the first driving edge 333 and the second driving edge 334, and the included angle θ2 is greater than 50 degrees.

In use of the anti-slip fastener driver 10, the driving portion 30 can be inserted into the a driving hole 91 of a damaged screw 90 in a slant direction, allowing the top end face 31, a corner 325 formed between the top short side 321 and the second lateral side 324, and the first and second driving edges 333 and 334 to engageably contact with an inner wall face 911 and a inner bottom face 912 of the driving hole 91, assisting in driving of the screw 90.

Thus, the anti-slip fastener driver 10 can achieve an excellent anti-slip effect by the above structure and, thus, can smoothly drive the screw 90 even if the driving hole 91 of the screw 90 is damaged.

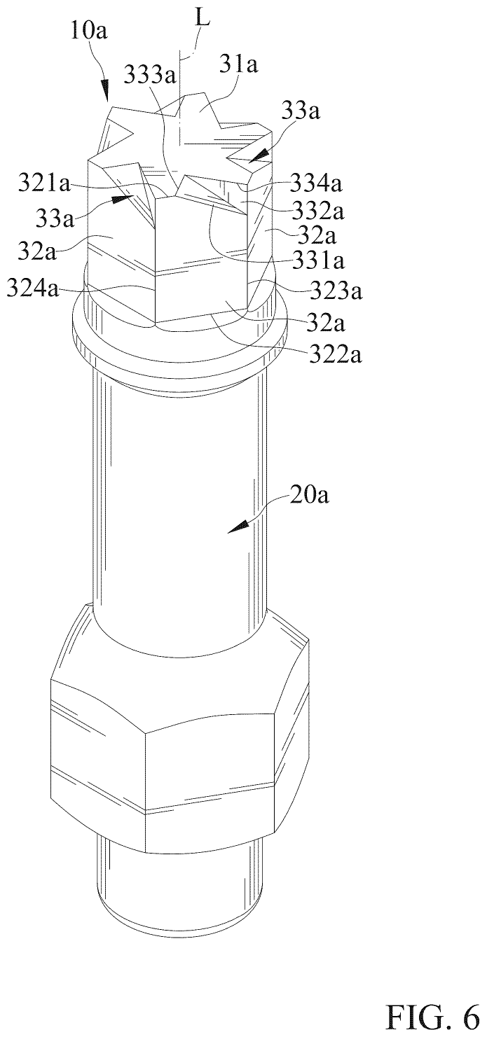

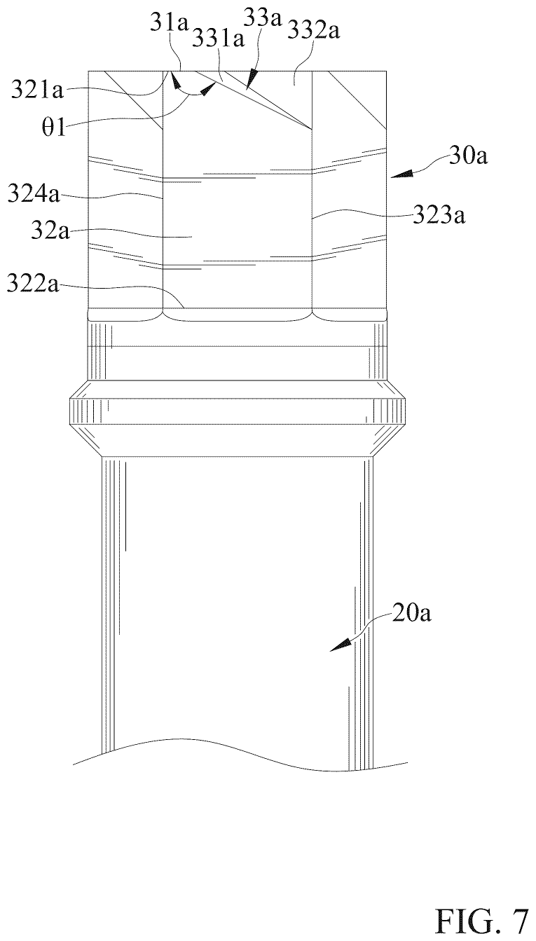

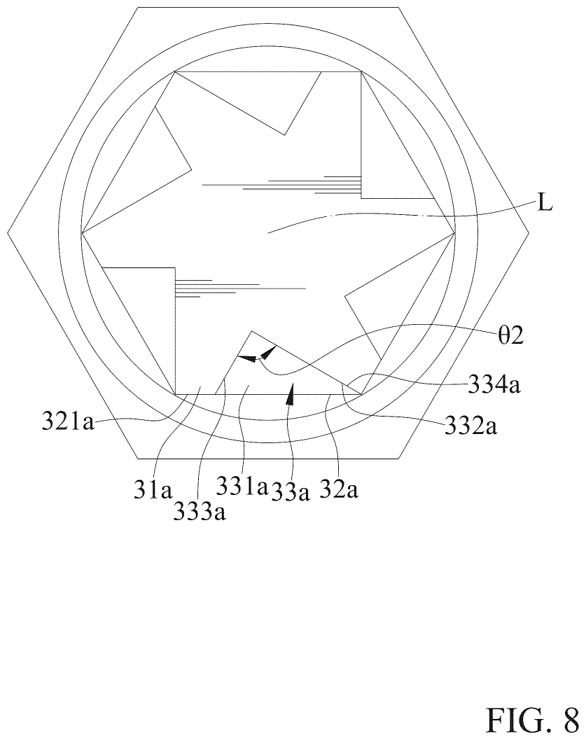

FIGS. 6-8 show an anti-slip fastener driver 10a of a second embodiment according to the present invention. The anti-slip fastener driver 10a includes a shank 20a and a driving portion 30a formed on an end of the shank 20a. The driving portion 30a defines a longitudinal axis L extending therethrough, allowing the driving portion 30a being rotatable about the longitudinal axis L. The driving portion 30a has a top end face 31a extending perpendicularly to the longitudinal axis L, a plurality of outer peripheral faces 32a arranged continuous and surrounding the longitudinal axis L, and a plurality of driving recesses 33a formed on the top end face 31a and sequentially arranged around the longitudinal axis L. Each of the plurality of driving recesses 33a has a bevel face 331a inclinedly connected to the top end face 31a at an inclination angle θ1, and a driving face 332a perpendicularly connected to the top end face 31a.

Further, the number of the plurality of outer peripheral faces 32a is six to cause the driving portion 30a having a regular hexagonal cross-sectional shape, and the number of the plurality of driving recesses 33a is six. Thus, the top end face 31a in the embodiment is formed as an outwardly extending fan-shaped surface from the longitudinal axis L.

Each of the plurality of outer peripheral faces 32a is a right trapezoid surface, which has a top short side 321a adjacently connected to the top end face 31a, a bottom long side 322a parallel to the top short side 321a and connected to the shank 20a, and a first lateral side 323a and a second lateral side 324a parallel to each other and respectively connected to adjacent outer peripheral faces 32a. The first lateral side 323a is lees than the second lateral side 324a.

The length of the top short side 321a may be less than a half of the length of bottom long side 322a. In the embodiment, the length of the top short side 321a is less than one third of the length of bottom long side 322a.

Furthermore, the inclination angle θ1 of the embodiment is in a range of 130 degrees to 175 degrees, preferably in the range of 150 degrees to 160 degrees.

Each of the plurality of driving recesses 33a further has a first driving edge 333a adjacently connected to the top end face 31a and the respective bevel face 331a, and a second driving edge 334a adjacently connected to the top end face 31a and the respective driving face 332a.

In the embodiment, an included angle θ2 is formed between the first driving edge 333a and the second driving edge 334a, and the included angle θ2 is greater than 80 degrees.

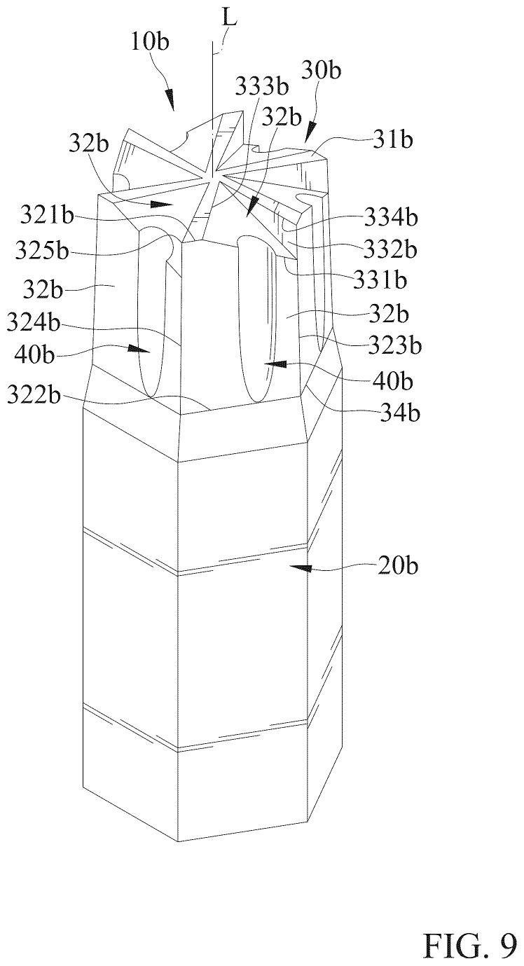

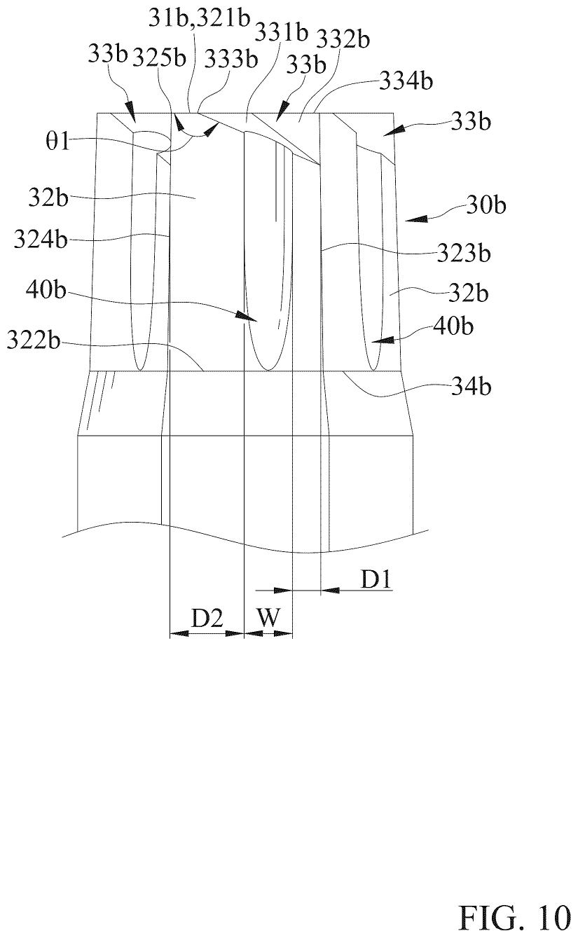

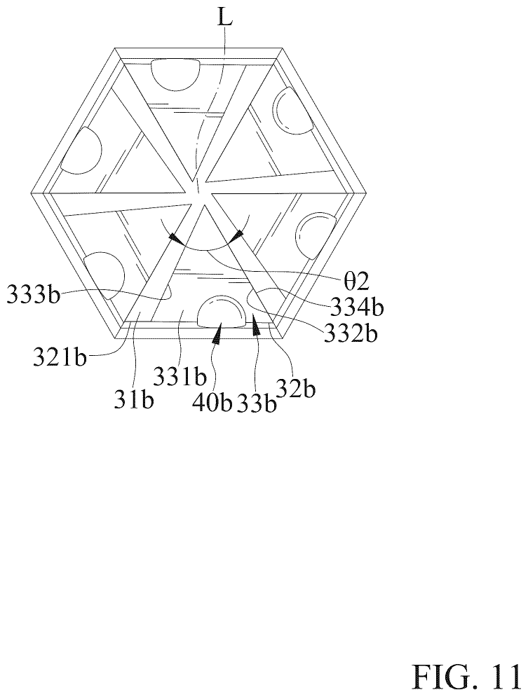

FIGS. 9-11 show an anti-slip fastener driver 10b of a third embodiment according to the present invention. The anti-slip fastener driver 10b includes a shank 20b, a driving portion 30b and a plurality of engaging recesses 40b. The driving portion 30b is formed on an end of the shank 20b and includes a top end face 31b, a plurality of outer peripheral faces 32b radially positioned about a longitudinal axis L of the driving portion 30b, a plurality of driving recesses 33b formed on the top end face 31b and sequentially arranged about the longitudinal axis L, and a base 34b spaced from the top end face 31b along the longitudinal axis L. Each of the plurality of driving recesses 33b has a bevel face 331b inclinedly connected to the top end face 31b at an inclination angle θ1, and a driving face 332b perpendicularly connected to the top end face 31b. The plurality of engaging recesses 40b are respectively formed on the plurality of outer peripheral faces 32b. Each of plurality of engaging recesses 40b extends into the driving portion 30b from the bevel face 331b of each of the plurality of driving recesses 33b towards the base 34b.

In the embodiment, the top end face 31b is flat and is perpendicular to the longitudinal axis L.

Furthermore, it is preferred that each of the plurality of engaging recesses 40b extends perpendicularly into each of the plurality of outer peripheral faces 32b.

In the preferred embodiment of the present invention, the number of the plurality of outer peripheral faces 32b is six and the resulting geometric profile of the driving portion 30b has a regular hexagonal cross-sectional shape. Additionally, the number of the plurality of driving recesses 33b is six.

Each of the plurality of outer peripheral faces 32b is a trapezoid surface, which has a top short side 321b adjacently connected to the top end face 31b, a bottom long side 322b adjacently connected to the base 34b, a first lateral side 323b, and a second lateral side 324b parallel to the first lateral side 323b. Further, the top short side 321b is shorter than a half of the bottom long side 322b, and the first lateral side 323b is shorter than the second lateral side 324b, so that each of the plurality of outer peripheral faces 32b is formed as a right trapezoid surface.

Further, each of plurality of engaging recesses 40b is spaced from the first lateral side 323b of each of the plurality of outer peripheral faces 32b by a first distance D1, and spaced from the second lateral side 324b of each of the plurality of outer peripheral faces 32b by a second distance D2, and the first distance D1 is less than the second distance D2 for the most efficient transfer of torque.

Furthermore, the inclination angle θ1 of the preferred embodiment of the present invention is in a range of 130 degrees to 175 degrees, preferably in the range of 150 degrees to 160 degrees.

Each of the plurality of driving recesses 33b further has a first driving edge 333b adjacently connected to the top end face 31b and the respective bevel face 331b, and a second driving edge 334b adjacently connected to the top end face 31b and the respective driving face 332b.

In the embodiment, an included angle θ2 is formed between the first driving edge 333b and the second driving edge 334b, and the included angle θ2 is between 50 degrees to 60 degrees.

Therefore, the plurality of outer peripheral faces 32b can physically press against a socket fastener, particularly the lateral sidewalls of a head portion from the socket fastener. Additionally, each of plurality of engaging recesses 40b extends into the driving portion 30b from the bevel face 331b of each of the plurality of driving recesses 33b towards the base 34b and also tapers from the bevel face 331b to the base 34b. This ensures that the additional gripping point extends along the length of the driving portion 30b for maximum grip engagement between the driving portion 30b and the socket fastener. Furthermore, it is preferred that a cross-section of each of plurality of engaging recesses 40b is a semi-circular profile. The semi-circular profile ensures that there are little to no high stress points in the driving portion 30b, thus increasing the overall longevity of the anti-slip fastener driver 10b.

In the preferred embodiment of the present invention, each of plurality of engaging recesses 40b is positioned specifically for the most efficient transfer of torque. In particular, each of plurality of engaging recesses 40b is spaced from the first lateral side 323b of each of the plurality of outer peripheral faces 32b by a first distance D1, and spaced from the second lateral side 324b of each of the plurality of outer peripheral faces 32b by a second distance D2. The proportion between the first distance D1, the second distance D2, and a width W40 of each of plurality of engaging recesses 40b is 4:6:9 for the most efficient transfer of torque.

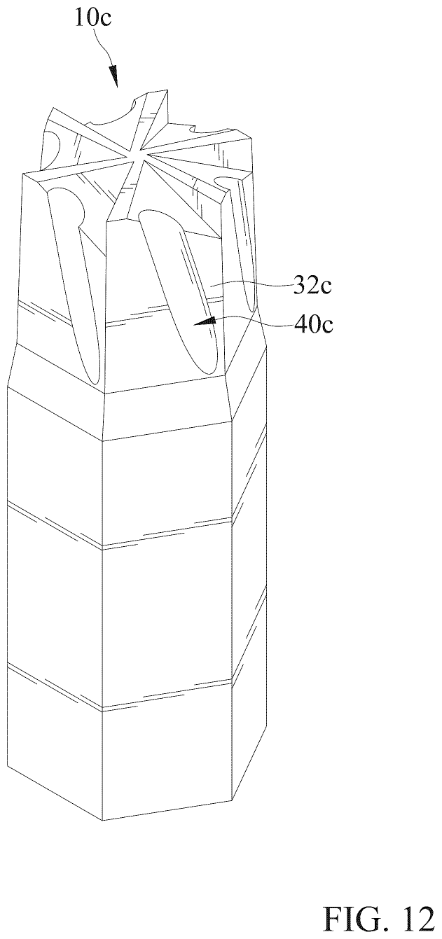

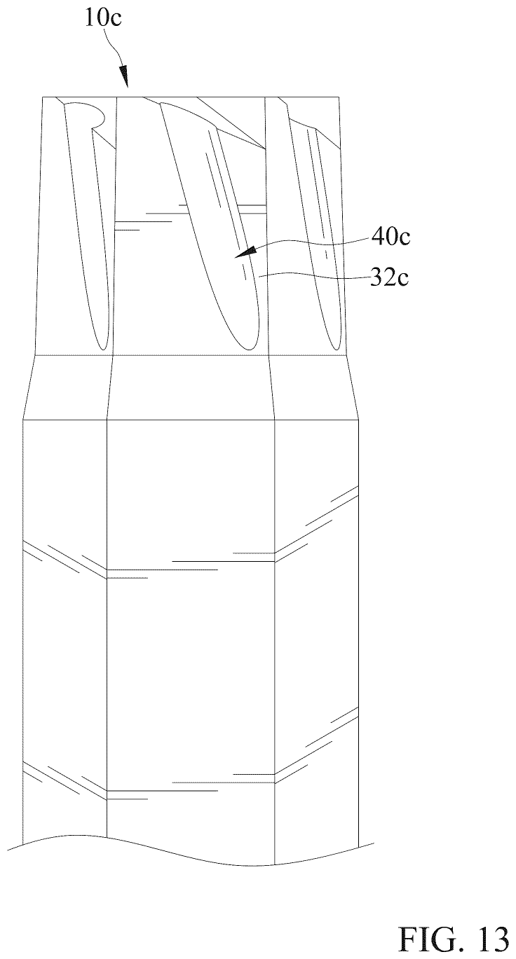

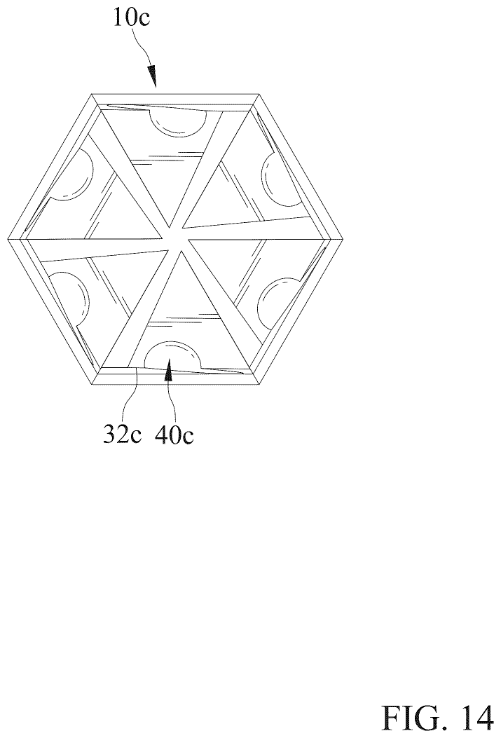

FIGS. 12-14 show an anti-slip fastener driver 10c of a fourth embodiment according to the present invention. The fourth embedment is substantially the same as the third embodiment. The main difference is that each of plurality of engaging recesses 40c extends obliquely into each of the plurality of outer peripheral faces 32c.

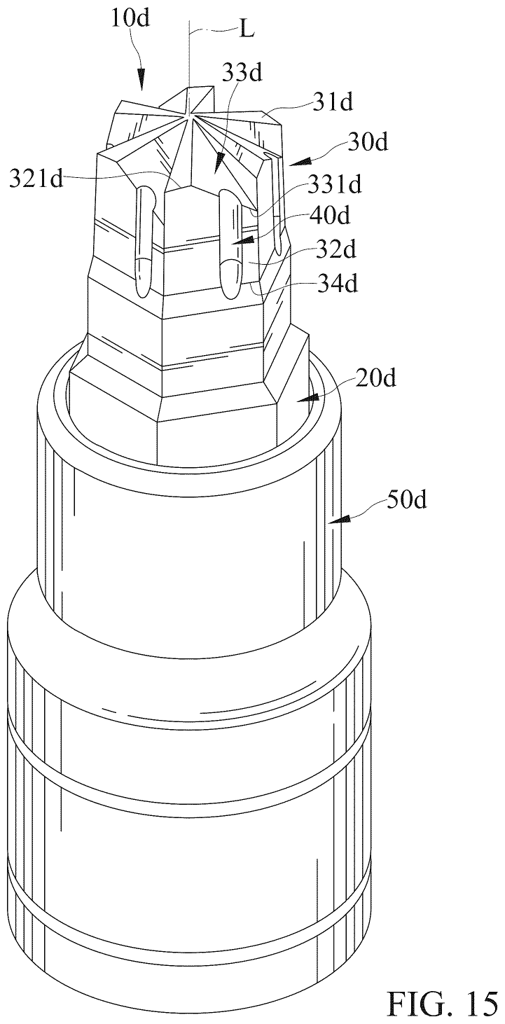

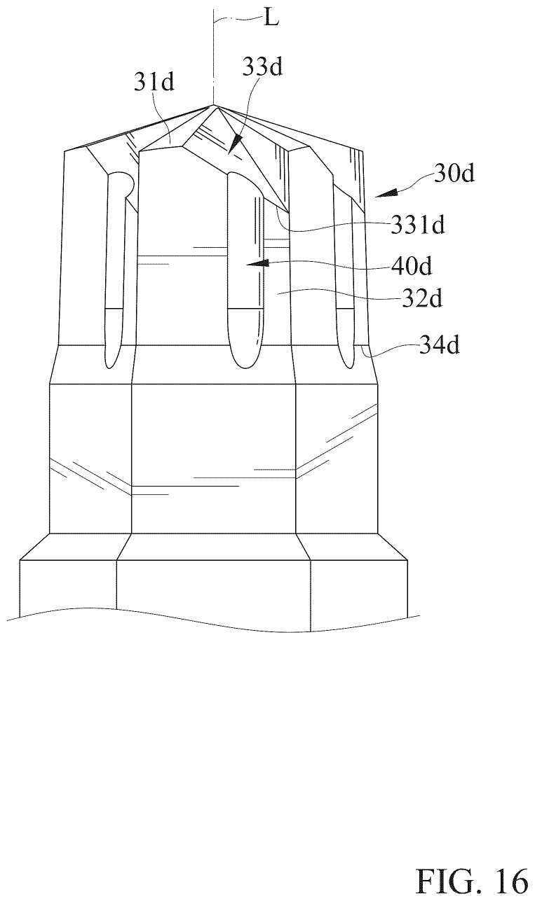

FIGS. 15 and 16 show an anti-slip fastener driver 10d of a fifth embodiment according to the present invention. The fifth embedment is substantially the same as the third embodiment. The main difference is that the top end face 31d is inclined and slopes downward from the longitudinal axis L to the top short side 321b of each of the plurality of outer peripheral faces 32d. Each of the plurality of engaging recesses 40d extends into the driving portion 30d from the bevel face 331d of each of the plurality of driving recesses 33d towards the base 34d, and also crosses over to the base 34d. Furthermore, the shank 20d of the embodiment is coupled to a socket 50d for driving.

Although specific embodiments have been illustrated and described, numerous modifications and variations are still possible without departing from the scope of the invention. The scope of the invention is limited by the accompanying claims.

1. An anti-slip fastener driver comprising:
a shank;
a driving portion formed on an end of the shank and including a top end face, a plurality of outer peripheral faces radially positioned about a longitudinal axis of the driving portion, a plurality of driving recesses formed on the top end face and sequentially arranged about the longitudinal axis, and a base spaced from the top end face along the longitudinal axis, wherein each of the plurality of driving recesses has a bevel face inclinedly connected to the top end face at an inclination angle, and a driving face perpendicularly connected to the top end face; and
a plurality of engaging recesses respectively formed on the plurality of outer peripheral faces, wherein each of plurality of engaging recesses extends into the driving portion from the bevel face of each of the plurality of driving recesses towards the base.

2. The anti-slip fastener driver as claimed in claim 1, wherein the number of the plurality of outer peripheral faces is six, and the driving portion has a regular hexagonal cross-sectional shape, and wherein the number of the plurality of driving recesses is six.

3. The anti-slip fastener driver as claimed in claim 2, wherein each of the plurality of outer peripheral faces is a trapezoid surface having a top short side adjacently connected to the top end face, a bottom long side adjacently connected to the base, a first lateral side, and a second lateral side parallel to the first lateral side.

4. The anti-slip fastener driver as claimed in claim 3, wherein the top short side is shorter than a half of the bottom long side.

5. The anti-slip fastener driver as claimed in claim 3, wherein the first lateral side is shorter than the second lateral side.

6. The anti-slip fastener driver as claimed in claim 3, wherein each of plurality of engaging recesses is spaced from the first lateral side of each of the plurality of outer peripheral faces by a first distance and spaced from the second lateral side of each of the plurality of outer peripheral faces by a second distance, and wherein the first distance is less than the second distance.

7. The anti-slip fastener driver as claimed in claim 3, wherein each of plurality of engaging recesses extends perpendicularly into each of the plurality of outer peripheral faces.

8. The anti-slip fastener driver as claimed in claim 3, wherein each of plurality of engaging recesses extends obliquely into each of the plurality of outer peripheral faces.

9. The anti-slip fastener driver as claimed in claim 1, wherein the inclination angle is in a range of 130 degrees to 175 degrees.

10. The anti-slip fastener driver as claimed in claim 1, wherein each of the plurality of driving recesses further has a first driving edge adjacently connected to the top end face and the respective bevel face, and a second driving edge adjacently connected to the top end face and the respective driving face.

11. The anti-slip fastener driver as claimed in claim 10, wherein an included angle is formed between the first driving edge and the second driving edge, and wherein the included angle is between 50 degrees to 60 degrees.

12. The anti-slip fastener driver as claimed in claim 1, wherein the top end face is flat.

13. The anti-slip fastener driver as claimed in claim 3, wherein the top end face is inclined and slopes downward from the longitudinal axis to the top short side of each of the plurality of outer peripheral faces.

14. The anti-slip fastener driver as claimed in claim 13, wherein each of the plurality of engaging recesses extends into the driving portion from the bevel face of each of the plurality of driving recesses towards the base and crosses over to the base.
